(19) United States
(12) Patent Application Publication
(10) Pub. No.: US 2018/0334377 A1
(43) Pub. Date: Nov. 22, 2018

(54) TRANSPORTABLE LIQUID FUEL CADDY

(71) Applicant: Paul Allen Hart, Warren, OH (US)

(72) Inventor: Paul Allen Hart, Warren, OH (US)

(21) Appl. No.: 15/982,868

(22) Filed: May 17, 2018

Related U.S. Application Data
(60) Provisional application No. 62/509,725, filed on May 22, 2017.

(51) Int. Cl. B67D 7/84; B60R 9/06; B62B 3/10; B62B 5/00; B62B 5/06; B67D 7/04; B67D 7/72

(52) U.S. Cl. CPC B67D 7/845; B60R 9/06; B62B 3/104; B62B 2202/02; B62B 5/06; B67D 7/04; B67D 7/72; B62B 5/0003

(57) ABSTRACT

A transportable liquid fuel caddy that easily attaches to the outside of any vehicle with a approved hitch receiver. Provisions within the design provide a secure attachment of the fuel caddy to the vehicle that is free of rattle. After attachment to the vehicle, the fuel caddy can be lifted and lowered via hand cranking or pushing “lift/lower” button on electromechanical version. The fuel caddy can be filled at the refueling station without being removed from the vehicle, gas fumes do not enter the vehicle as the fuel caddy remains mounted to the outside of the vehicle during transportation. The lever pump integrated into the fuel caddy is pumped a few times to build up low pressure in the fuel tanks to push the fuel out of the tanks at the time of dispensing.

### BACKGROUND

This invention relates to a transportable liquid (non-pressurized) fuel caddy, as opposed to a non-transportable gas caddy (U.S. Pat. No. 5,667,113 to Clark & Eureka (1997)). The transportable gas caddy attaches to the back of any vehicle that has a 2″ or 1¼″ approved hitch drawbar receiver. The drawbar of the transportable liquid fuel caddy is designed to eliminate the rattling caused by the loose fit between the hitch drawbar and receiver during transportation. The transportable liquid fuel caddy provides a method of mechanically or electro-mechanically assisting the user to lift the transportable liquid fuel caddy to a safe transportation height in relation to the vehicle, for transportation to the fuel supply station/location and then lowering it at destination. All known liquid fuel caddies currently on the market transfer the liquid fuel by gravity feed, hand pump nozzles or utilize a manual rotary drum pump. The issue with a manual rotary drum pump is that the operator has to be at the liquid fuel caddy actuating the pump while simultaneously dispensing the fuel from the nozzle.

PROBLEM TO BE SOLVED: You cannot fill a fuel container while it is inside a vehicle. This solution mounts the fuel container to the outside of the vehicle, via a standard 2″ or 1¼″ approved hitch receiver and drawbar of the fuel caddy. Mounting the fuel caddy outside of the vehicle prevents fuel fumes from emitting inside the vehicle. Standard vehicle hitch assemblies rattle as the vehicle is in motion. This rattling can be an unpleasant noise to the vehicle driver and also distracting the driver to the point of not being as cautious to other things around them. The attachment method of the transportable liquid fuel caddy employs a mechanism to eliminate rattle.

U.S. Pat. No. 5,667,113 to Clark & Eureka (1997) claims a wheeled fuel tank that has an axle with attached rotating wheels mounted to the back wall of the container. This invention mounts the fuel containers inside of an external rigid frame. The axels with rotating wheels are then attached to the external rigid frame. This same external rigid frame has all the lifting and lowering mechanism components integral to it. The mechanical or electro-mechanical lifting and lowering mechanism lifts the transportable liquid fuel caddy from the ground to a known height by a vertical distance delta from the hitch drawbar and the bottom of the external rigid frame, and the opposite when lowering to the ground. Empty and full fuel containers (gas cans) can be strenuous to lift up and into a vehicle and up and out to lower to the ground. An empty 20-30 gallon liquid fuel caddy can weigh an average of 30 lbs. A full 20-30 gallon liquid fuel caddy can weigh an average of 180 lbs. The transportable liquid fuel caddy eliminates the strenuous activity of lifting and lowering by integrating a manual or automatic lifting and lowering mechanism into it.

Other liquid fuel caddies use gravity, hand pump nozzles and drum pumps to dispense the liquid fuel from the container. When using gravity to feed the fuel from the container to the nozzle, the height of the fuel container needs to be higher than the height of the nozzle when dispensing the liquid fuel. Using a hand pump nozzle similar to what is shown in U.S. Pat. No. D516,673 to Chisholm & Alex (2006) will allow for the nozzle height to be higher than the fuel container and also allow the operator to be as far away from the fuel container as the hose length and pump capacity allow. Squeezing the hand pump nozzle can be strenuous, especially when dispensing large volumes of fuel. Drum pumps can dispense large volumes of fuel without strenuous activity or concern about the height of the dispensing nozzle to fuel container relationship, but the operator has to be at the fuel container actuating the drum pump. It is not safe for the operator to be at the fuel container when dispensing fuel because the container/tank being filled can overflow and spill on equipment or ground causing slip hazards or risk of fuel combustion. The transportable fuel caddy has an integral lever air pump that draws in air from atmosphere via a vacuum produced from a retracting piston. The air in the piston is then pressed into the fuel container when the piston is advanced by the hand lever. Within a few cycles or pumps, there is a high amount of lightly compressed air (maximum 10 psi) inside the fuel container. The compressed air is stored energy inside the fuel container that provides pressure to push the liquid fuel through the hose when the nozzle valve is released. This method of fuel dispensing allows the operator to be at the point of fuel dispensing when the liquid fuel is transferring to the dispensing nozzle from the fuel container. The volume of air compressed into the fuel container, and the amount of pressure of the compressed air determine how much fuel can be dispensed, how fast the fuel will transfer from container to nozzle and the height (head) that the nozzle can be in relation to the fuel container. The lever of this pump is long so that a mechanical advantage is employed into the pumping system. This mechanical advantage allows for non-strenuous pumping.

### SUMMARY

The aforementioned transportable non-pressurized liquid fuel caddy provides:
Safety to those dispensing fuel because they are at the point of dispensing.
Relief to strenuous activity of lifting, lowering and hand pumping.
Elimination of rattling in the attachment method to vehicle.
Ease of filling the liquid fuel container at the re-fueling station.
Elimination of harmful and potentially combustible fuel vapor buildup in the vehicle.

### DRAWINGS

FIG. 1 is a side view of the fuel caddy constructed in accordance with the invention attached to the back of a vehicle that is not constructed in accordance with this invention.

FIG. 2 is a perspective view, with accompanying detail view of a vehicle with a receiver that has the drawbar of the fuel caddy inserted into it. The view illustrates the external features of the mechanism that creates the solid connection of the vehicle receiver and fuel caddy drawbar.

FIG. 3 is a cross section view of the fuel caddy drawbar 12 of (FIG. 2) constructed in accordance with the invention.

FIG. 4 is a perspective view of the fuel caddy constructed in accordance with the invention, showing the back side of the fuel caddy or the side that attaches to the vehicle.

FIG. 5 is a perspective view of a fuel caddy constructed in accordance with the invention, showing the front or operator side of the fuel caddy.

FIG. 6 is a partial cross section view of 10 (FIG. 1) to illustrate how the drawbar attaches to the external frame of the fuel caddy.

FIG. 7 is a perspective view of the fuel caddy external frame 20 (FIG. 2) with integral lifting mechanism shown in FIG. 6.

FIG. 8 is a perspective view of the integral double acting double acting double acting lever air pump 37 of FIG. 2.

FIG. 9 is a cross section view of the integral double acting double acting lever air pump 37 of FIG. 2.

### DETAILED DESCRIPTION

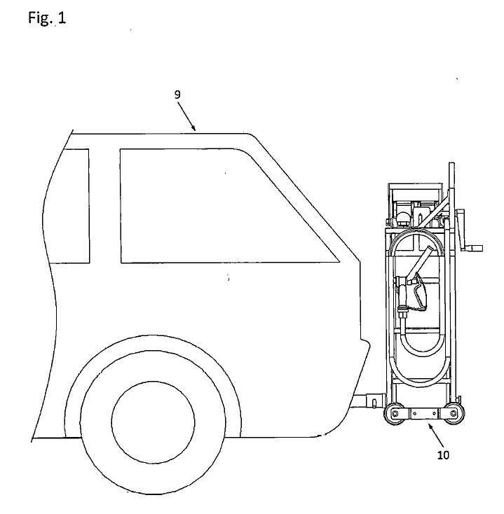

FIG. 1 is a side view of a vehicle 9 with the fuel caddy 10 attached to it. The fuel caddy 10 is in the raised position or lifted up off of the ground so that it can be transported.

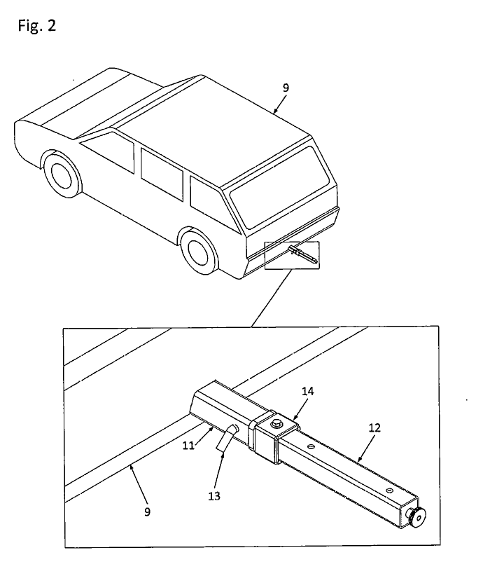

FIG. 2 is a perspective view, with accompanying detail view of vehicle 9 with integral receiver 11 that has the drawbar 12 with integral sleeve 14 of the fuel caddy inserted into it. Hitch pin 13 is a commercially available component that is not integral to vehicle 9 or fuel caddy 10.

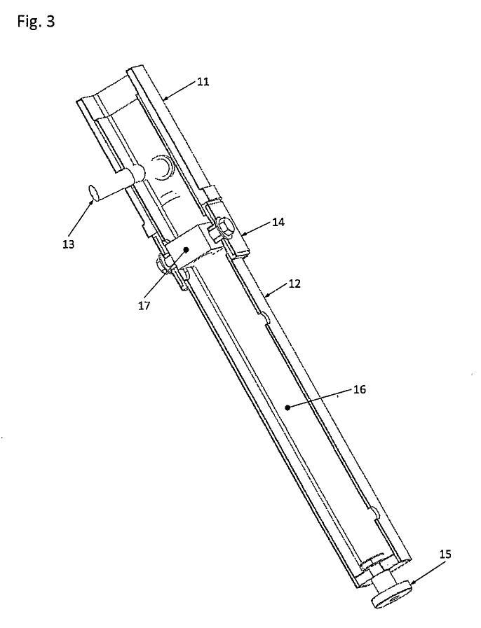

FIG. 3 is a partial cross section view of drawbar 12 (FIG. 2) receiver 11 (FIG. 2) and sleeve 14 (FIG. 2), with knob 15, screw 16 and trunnion 17 not cross sectioned. When drawbar 12 is inserted into receiver 11 and the hitch pin holes of each are aligned, hitch pin 13 (FIG. 2) is inserted into the holes to provide a pinned connection between drawbar 12 and receiver 11.

As knob 15 is rotated, torque is transmitted to the connected screw 16. Screw 16 provides axial movement to trunnion 17 via the threaded hole in trunnion 17. Sleeve 14 travels axially with trunnion 17 because the two components are connected by bolts through slots in drawbar 12.

Sleeve 14 will then be pushed up against receiver 11 by means of the force generated by the rotating screw 16 interacting with non-rotating threaded trunnion 17. The force applied to the receiver 11 by sleeve 14 creates a shear force on hitch pin 13 by trying to separate drawbar 12 from receiver 11, thus a rigid connection is created between drawbar 12 from receiver 11. The intention of this rigid pinned connection is to eliminate rattling within the connection when vehicle 9 (FIG. 2) is in motion.

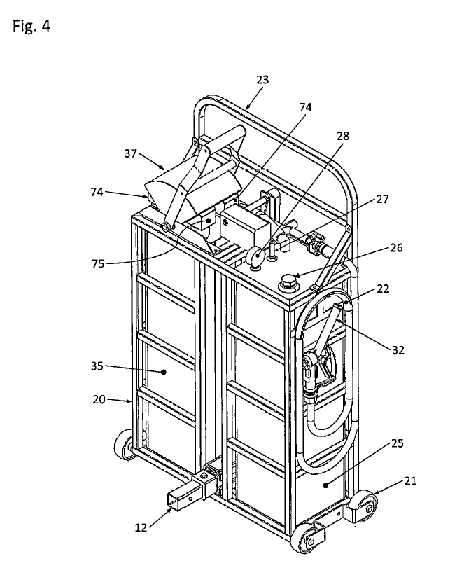

FIG. 4 is a perspective view of fuel caddy 10 shown in (FIG. 1). Drawbar 12 is shown in the raised and clamped position. The fuel caddy external rigid frame 20 protects tank 25 and tank 35 while providing structural mounting for wheels 21, hose hanger 22, removable handle 23 and double acting double acting lever air pump 37. This design intentionally utilized two tanks (tank 25 and tank 35) so that each tank could be on either side of drawbar 12, thus balancing the load of the fuel caddy (FIG. 1) when empty and also full. At the bottom of tank 25 and tank 35 there is a connecting tube that allows fuel to pass between the two tanks to keep the fuel level equal in both tanks.

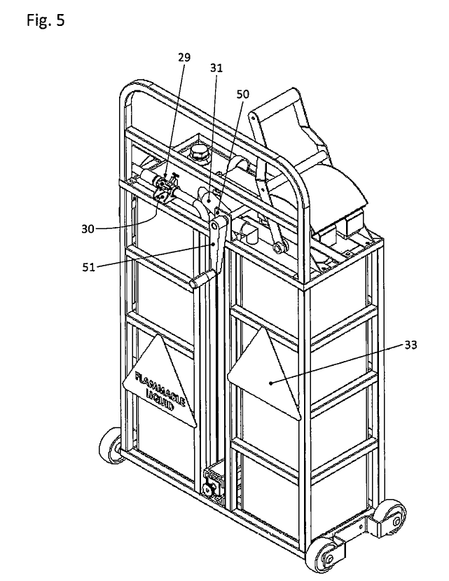

FIG. 5 is a perspective view of fuel caddy 10 shown in (FIG. 1). The fuel caddy external rigid frame 20 (FIG. 2) provides structural mounting for shut off valve mounting bracket 30, signage 33 and shaft bearing housing bracket 50.

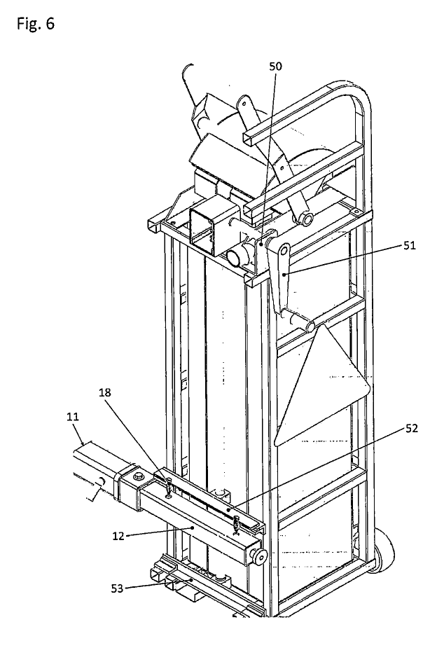

FIG. 6 is a partial cross section view of 10 (FIG. 1) to illustrate how the fuel caddy is attached to drawbar 12 after drawbar 12 has already been attached to the receiver 11 of vehicle 9 (FIG. 1). Upon drawbar connection to vehicle, the fuel caddy is introduced to the drawbar 12 for attachment and lifting of the fuel caddy. The fuel caddy is positioned by the user so that the guide pins 18 are axially aligned for insertion into the mating holes of drawbar 12. Once the guide pins are aligned, the user cranks handle 51 to lower top clamp member 52 until it makes contact with drawbar 12. After contact is made and user continues to crank handle 51, the fuel caddy 10 (FIG. 1) will begin to lift off of the ground until drawbar makes contact with the bottom clamp member 53. The aforementioned procedure raises and then securely clamps fuel caddy 10 (FIG. 1) to drawbar 12. The opposite procedure will unclamp and lower the fuel caddy 10 (FIG. 1) to the ground.

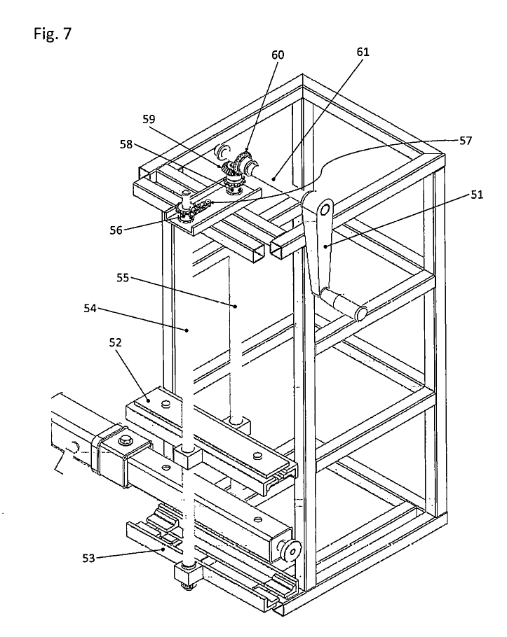

FIG. 7 is a perspective view of the fuel caddy external frame 20 (FIG. 4) with integral lifting mechanisms used to produce the lifting, clamping, unclamping and lowering of the fuel caddy 10 (FIG. 1). Handle 51 is cranked or rotated to provide rotation to attached shaft 61. Miter gear 60 is connected to shaft 61, as shaft 61 rotates it provides right angle power transmission to miter gear 59. Miter gear 59 provides rotation to connected screw 55. Sprocket 58 is also connected to screw 55 and it provides rotation to sprocket 56 via chain 57. Sprocket 56 is connected to screw 54. Ultimately rotation of handle 51 provides rotation to screws simultaneously and lifts or lowers top clamp member 52 via the threaded holes that screws 54 and 55 pass through in top clamp member 52.

An electric motor that runs off of a battery or the 12V connection typically used for trailer lighting can be added in line with shaft 61 to provide automatic power transmission to the aforementioned drive train. Also an electric motor can be added in line to shaft 55 to provide automatic power transmission to the aforementioned drive train.

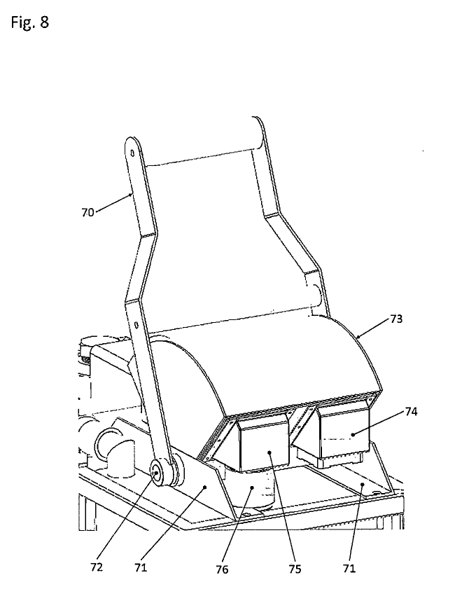

FIG. 8 is a perspective view of the integral double acting lever air pump 37 of (FIG. 2). The double acting lever air pump 37 of (FIG. 2) is rigidly mounted to the external frame 20 (FIG. 4) through a bolted connection of pump base 71. Pump base 71 has a hole that houses shaft 72. Shaft 72 is the pivot point for connected lever 70. When the user is ready to dispense fuel from the fuel caddy they will push and pull lever 70 to actuate the pump. Pump housing 73 is rigidly mounted to pump base 71. Air filter valve cover 74, valve cover 75, air filter valve cover 74 (FIG. 4) and valve cover 75 (FIG. 4) are rigidly mounted to pump housing 73. Valve connecting tube 76 attaches the valve cover 75 to tank 35 (FIG. 4).

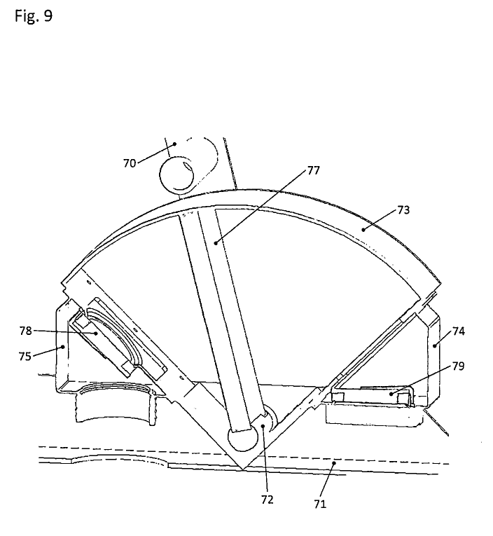

FIG. 9 is a cross section view of the integral double acting lever air pump 37 of (FIG. 2). Lever flap 77 is rigidly connected to shaft 72. Lever flap 77 follows lever 70 (FIG. 8) as both of them move with respect to shaft 72. Lever 70 can rotate in either direction until it hits the wall of pump housing 73. Because pump housing 73 and all mating components are sealed, the assembly is considered air tight. As lever flap 77 moves and approaches either adjacent wall of pump housing 73, the air trapped between the face of lever flap 77 and the adjacent pump housing 73 wall will be compressed and forced through outlet valve 78 that is enclosed in valve cover 75 on each of the pump housing 73 walls. As lever flap 77 withdrawals from the wall of pump housing 73, a vacuum is created and air is drawn in through air filter valve cover 74 and inlet valve 79 (need to add to FIG. 9).

As the user continues to stroke the integral double acting lever air pump 37 of (FIG. 2) air pressure is built up in tank 25 (FIG. 4) and tank 35 (FIG. 4). Pressure relief valve 27 (FIG. 4) will ensure that the air pressure in tank (FIG. 4) and tank 35 (FIG. 4) does not exceed the safe working pressure limit. Pressure gauge 28 (FIG. 4) informs the user when they have sufficiently reached an assigned amount of pressure to dispense fuel. The connecting tube 31 (FIG. 5) is an air passage between tank 25 (FIG. 4) and tank 35 (FIG. 4) to allow for the air pressure to be equally distributed between the two tanks.

### REFERENCE NUMERALS

9—vehicle
10—fuel caddy
11—receiver
12—drawbar
13—hitch pin
14—sleeve
15—knob
16—screw
17—trunnion
18—guide pins
20—external rigid frame
21—wheels
22—hose hanger
23—removable handle
25—tank
26—tank cap
29—shut off valve (need to incorporate into OPERATION)
30—shut off valve mounting bracket (do I need?)
31—connecting tube
32—dispensing nozzle
33—signage
35—tank
37—double acting lever air pump
50—shaft bearing housing bracket
51—crank handle
52—top clamp member
53—bottom clamp member
54—screw
55—screw
56—sprocket
57—chain
58—sprocket
59—miter gear
60—miter gear
61—shaft
70—lever
71—pump base
72—shaft
73—pump housing
74—air filter valve cover
75—valve cover
76—connecting tube
77—lever flap
78—outlet valve
79—inlet valve

### OPERATION

In operation one will insert drawbar 12 to the receiver 11 and align the hitch pin holes of both components and insert hitch pin 13 through the hitch pin holes. Then knob 15 will be turned to clamp drawbar 12 to the receiver 11 to provide a clamped connection that is secure and free from rattle during transportation. Once drawbar 12 installation is complete, the fuel caddy 10 will be wheeled over to drawbar 12 and the guide pins 18 will be positioned over mating holes in drawbar 12. Then fuel caddy 10 will be lifted off of the ground in relation to drawbar 12 and securely clamped by cranking handle 51 or pushing “lift” button on electric version.

With fuel caddy 10 properly attached to vehicle 9, the user will drive to the refueling location and fill fuel caddy 10 with liquid fuel without having to remove fuel caddy 10 from vehicle 9. While the user is traveling from the refueling station, the fumes from the filled fuel caddy 10 will not hinder them because they will be outside of the vehicle.

Once the user arrives at destination, they can either dispense fuel from the fuel caddy 10 while still attached to the vehicle 9 or they can lower the fuel caddy 10 by cranking handle 51 to unclamp and lower or push “lower” button on the electric version. Then the fuel caddy can be wheeled to the location of use or storage.

The user will dispense fuel from the fuel caddy 10 either by gravity feed or the use of integral double acting lever air pump 37. To use the pump the user will push and pull lever 70 to build up pressure in tanks 25 and 35 that will be used to force fuel out of dispensing nozzle 32. The dispensing nozzle 32 with attached hose can be removed from the hose hanger and used for fueling away from the fuel caddy 10.

1. A transportable liquid fuel caddy, comprising:
An external rigid frame that protects fuel tanks while providing structural mounting for wheels, hose hanger, removable handle and double acting lever air pump.
A drawbar that inserts into a receiver and has components that provide a secure connection that eliminates rattling.
A mechanical or electromechanical lifting and lowering mechanism that eliminates the strenuous activity of manually lifting the fuel caddy off of the ground to attach it to a vehicle, and then lifting again to detach the fuel caddy from the vehicle.
An integral lever pump that is used to take in air from atmosphere and compress the air into the fuel caddy to provide stored air pressure for expelling fuel from the tanks of the fuel caddy.
